(19) United States
(12) Patent Application Publication
(10) Pub. No.: US 2023/0024333 A1
(43) Pub. Date: Jan. 26, 2023

(54) MONOPOLE LOW-PROFILE PLATFORM ASSEMBLIES

(71) Applicant: CommScope Technologies LLC, Hickory, NC (US)

(72) Inventors: Jyoti Ojha, Southlake, TX (US); Dale Heath, Fort Worth, TX (US); Brian Cross, Double Oak, TX (US)

(21) Appl. No.: 17/857,694

(22) Filed: Jul. 5, 2022

Related U.S. Application Data
(60) Provisional application No. 63/223,238, filed on Jul. 19, 2021.

(51) Int. Cl. E04G 3/24; E04G 7/02; H01Q 1/44; H01Q 9/30

(52) U.S. Cl. CPC E04G 3/243; E04G 7/02; H01Q 1/44; H01Q 9/30

(57) ABSTRACT

The present disclosure describes monopole platform assembly. The platform assembly includes a frame, the frame including an elongate, hollow main support member of rectangular cross-section, and a plurality of elongate, hollow auxiliary support members of rectangular cross-section attached orthogonally to the main support member; a mounting plate coupled to an end of the main support member; at least two grating edge members coupled to the auxiliary support members; and a grating, the grating being supported by the two grating edge members, the auxiliary support members, and the main support member. The opposing ends of each auxiliary support member extend a distance outwardly passed the grating edge members such that the extended ends of the auxiliary support members are positioned to support a horizontal pipe member. The extended ends of the auxiliary support members each include a feature configured to enable fixing of the horizontal pipe member thereto. Additional platform assemblies are described herein.

### RELATED APPLICATION(S)

The present application claims priority to and the benefit of U.S. Provisional Application Ser. No. 63/223,238, filed Jul. 19, 2021, the disclosure of which is hereby incorporated herein in its entirety.

### FIELD

The present invention relates generally to telecommunications equipment, and more particularly to monopole low-profile platform assemblies.

### BACKGROUND

Various types of towers have been constructed for the purpose of supporting one or more antennas, such as those for broadcasting television and radio signals. Some towers are specifically designed for transmitting and receiving cellular telephone signals and other types of radio frequency (RF) signals. As wireless data service demands have grown, a conventional response has been to increase the number and capacity of conventional cellular Base Stations (Macro-Cells). Such Macro-Cells are typically mounted on antenna towers. A conventional antenna tower has three or four legs on which antennas and supporting remote radio units (RRUs) are mounted. However, in some environments structures known as “monopoles” are used as mounting structures. Monopoles are typically employed when fewer antennas/RRUs are to be mounted, and/or when a structure of less height is required.

RF towers (including monopoles) are often designed to allow a person to climb to the top and remain there to install and/or repair RF antennas (e.g., cellular antennas) and other equipment connected to the tower. Platforms are typically mounted near the tops of RF towers (e.g., cellular towers) for supporting workers who may be responsible for installing and/or maintaining RF antennas (e.g., cellular antennas). Such platforms are designed to support the weight of a human and may also be used to support a number of the RF antennas. Horizontal members are mounted on and above the platform and vertical members are then mounted to the horizontal members and serve as mounting locations for antennas. Exemplary platforms are described in U.S. Patent Publication No. 2019/0348742 to Palmer and 2020/0123790 to de La Soujeole, the disclosures of which are incorporated by reference herein in full.

Typically, monopole platforms use square or round standoff arms, which can make vertical loading the limiting factor. Some other known designs utilize a clip angle (or pivot bracket) 40 to secure the triangular platform 20 to the horizontal members 14 of the platform assembly 10. See, e.g., FIGS. 1A-1B. As shown in FIGS. 1A-1B, these clip angles or pivot brackets 40 connect the frame members 24 of the triangular platform 20 to the horizontal members 14 of the platform assembly 10. In some instances, lateral wind forces acting on antennas mounted on the platform assembly 10 (and, in turn, on the vertical and horizontal members 14 discussed above) will generate a bending moment about the weak axis of the clip angles 40, which may lead to poor performance or even worse, failure. In addition, these clip angles and pivot brackets 40 are expensive because of the welding involved in their production. There may be a need for alternative ways to secure the platform frame members 24 to the horizontal members 14 to strengthen the connection and allow for easy fabrication and more efficient installation, while also reducing manufacturing costs.

### SUMMARY

A first aspect of the present invention is directed to a monopole platform assembly. The platform assembly includes a frame, the frame including an elongate, hollow main support member of rectangular cross-section and a plurality of elongate, hollow auxiliary support members of rectangular cross-section attached orthogonally to the main support member. The platform assembly also includes a mounting plate coupled to an end of the main support member; at least two grating edge members coupled to the auxiliary support members; and a grating, the grating being supported by the two grating edge members, the auxiliary support members, and the main support member. The opposing ends of each auxiliary support member extend a distance outwardly passed the grating edge members such that the extended ends of the auxiliary support members are positioned to support a horizontal pipe member. The extended ends of the auxiliary support members each include a feature configured to enable fixing of the horizontal pipe member thereto.

Another aspect of the present invention is directed to a monopole platform assembly. The platform assembly includes a frame, the frame including an elongate, hollow main support member of rectangular cross-section and a plurality of elongate, hollow auxiliary support members of rectangular cross-section attached orthogonally to the main support member. The platform assembly also includes a mounting plate coupled to an end of the main support member; at least two grating edge members coupled to the auxiliary support members; a grating, the grating being supported by the two grating edge members, the auxiliary support members, and the main support member; and one or more platform connection brackets. The opposing ends of each auxiliary support member extend a distance outwardly passed the grating edge members such that the extended ends of the auxiliary support members are positioned to support a horizontal pipe member, and each platform connection bracket further supports and secures the horizontal pipe member to a respective auxiliary support member.

Another aspect of the present invention is directed to a platform assembly. The platform assembly includes a mounting structure and at least three platforms. Each platform includes a frame, the frame including an elongate, hollow main support member of rectangular cross-section and a plurality of elongate, hollow auxiliary support members of rectangular cross-section attached orthogonally to the main support member. The platform assembly also includes a mounting plate coupled to an end of the main support member; at least two grating edge members coupled to the auxiliary support members; and a grating, the grating being supported by the two grating edge members, the auxiliary support members, and the main support member. The opposing ends of each auxiliary support member extend a distance outwardly passed the grating edge members such that the extended ends of the auxiliary support members are positioned to support a horizontal pipe member and the horizontal pipe member is coupled to at least two auxiliary support members of one of the platforms, and each platform is secured to the mounting structure by the mounting plate.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a perspective view of a known monopole platform assembly.

FIG. 1B is an enlarged view of one of the platforms for the assembly in FIG. 1A.

FIG. 2 is a top view of a platform assembly according to embodiments of the present invention.

FIG. 3A is a top view of a platform of the platform assembly of FIG. 2 according to embodiments of the present invention.

FIG. 3B is a perspective view of the platform of FIG. 3A.

FIG. 4 is a perspective view of a platform auxiliary support member according to embodiments of the present invention.

FIG. 5 is a perspective view of an alternative platform auxiliary support member according to embodiments of the present invention.

FIG. 6A is a perspective view a platform connection bracket according to embodiments of the present invention.

FIG. 6B is a side view of the platform connection bracket of FIG. 6A securing a horizontal member of a platform assembly to a platform auxiliary support member according to embodiments of the present invention.

FIG. 7A is a perspective view of an alternative platform connection bracket according to embodiments of the present invention.

FIG. 7B is a side view of the platform connection bracket of FIG. 7A securing a horizontal member of a platform assembly to a platform auxiliary support member according to embodiments of the present invention.

FIG. 8A is a perspective view of an alternative platform connection bracket according to embodiments of the present invention.

FIG. 8B is a side view of the platform connection bracket of FIG. 8A securing a horizontal member of a platform assembly to a platform auxiliary support member according to embodiments of the present invention.

FIG. 9A is a perspective view of an alternative platform connection bracket according to embodiments of the present invention.

FIG. 9B is a side view of the platform connection bracket of FIG. 9A securing a horizontal member of a platform assembly to a platform auxiliary support member according to embodiments of the present invention.

FIG. 10 is a perspective view of an alternative platform connection bracket according to embodiments of the present invention.

FIG. 11 is a perspective view of an alternative platform connection bracket according to embodiments of the present invention.

FIG. 12 is an exploded view of an alternative platform connection bracket according to embodiments of the present invention.

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “lateral”, “left”, “right” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. The device may be otherwise oriented (rotated 90 degrees or at other orientations) and the descriptors of relative spatial relationships used herein interpreted accordingly.

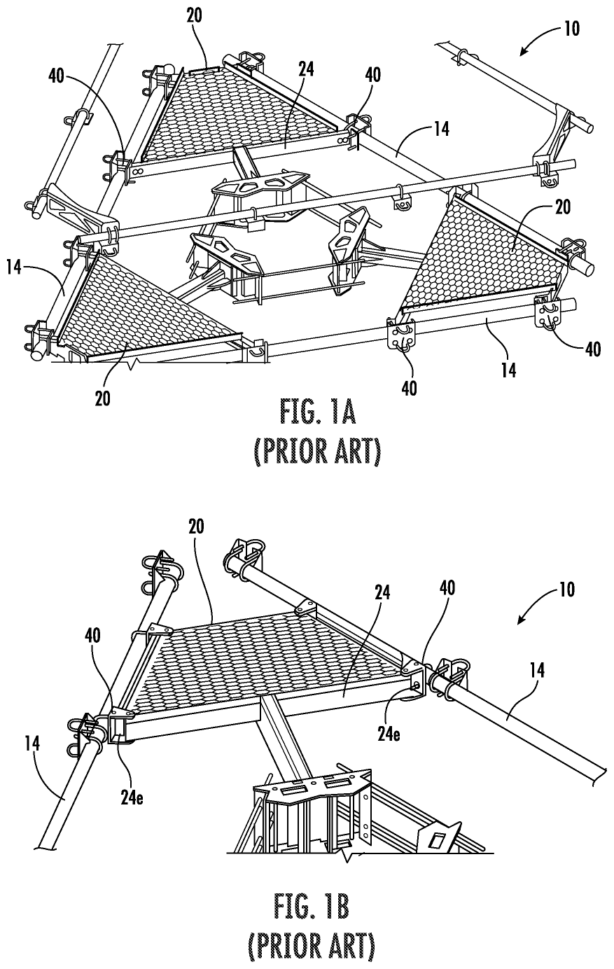

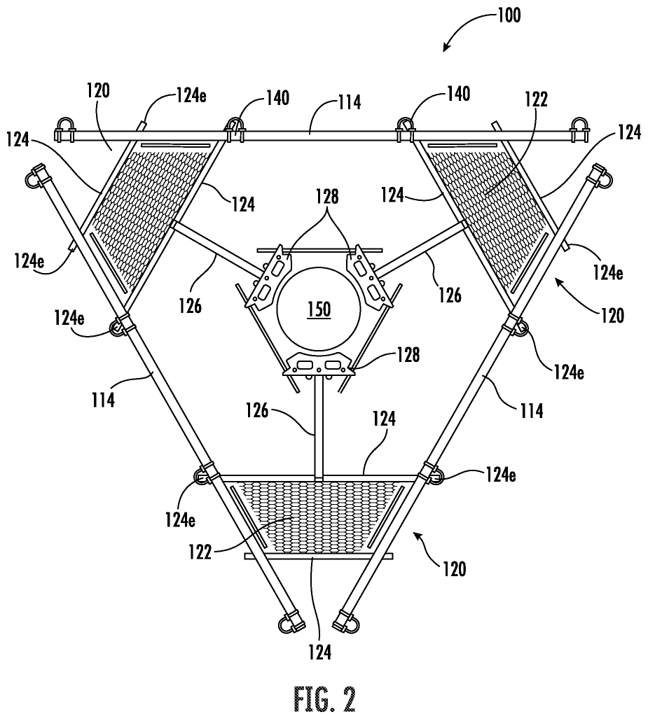

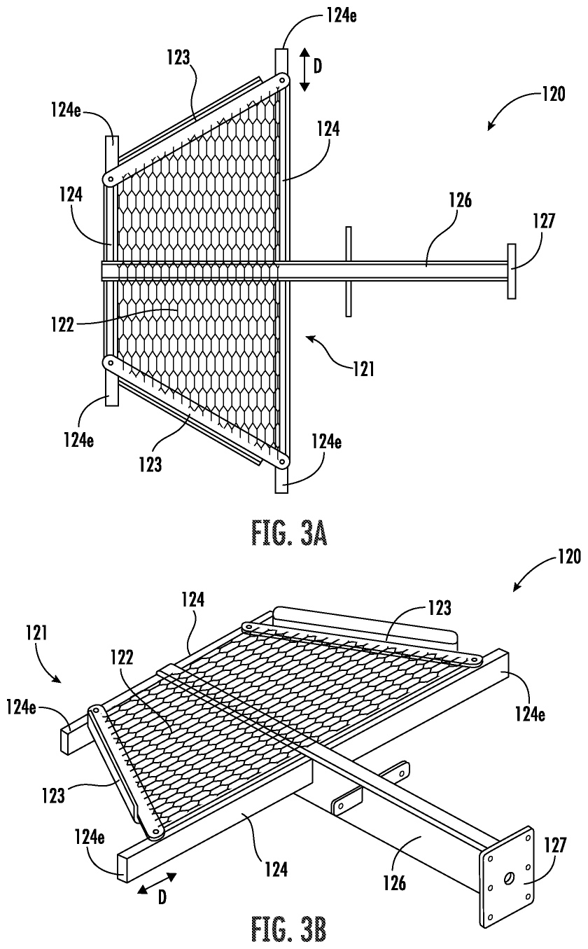

Referring now to the figures, a monopole platform assembly according to embodiments of the present invention, designated broadly at 100, is illustrated in FIG. 2. As shown in FIG. 2, similar to some known platform assemblies, for example, the assembly 10 shown in FIGS. 1A-1B, the monopole platform assembly 100 of the present invention may include three platforms (or standoffs) 120 secured to horizontal pipe members 114. As discussed in further detail below, the ends 124e of the platform (auxiliary) support (or frame) members 124 extend outwardly a sufficient distance (D) such that the horizontal pipe members 114 can be supported by and/or engage with the support members 124 (see e.g., FIGS. 3A-3B) and provide additional structural support to the platforms 120. In some embodiments, the distance (D) that the ends 124e of the support members 124 extend outwardly is at least equal to or greater than the outer diameter of the horizontal pipe member 114 to be supported (see, e.g., FIG. 2).

The horizontal pipe members 114 are oriented such that each pipe member 114 is coupled to at least one platform 120. The support members 124 of each platform 120 (e.g., the ends 124e of the support members 124) are configured to be secured to at least two of the horizontal pipe members 114 of the assembly 100. A mounting plate 127 of each platform 120 is configured to be secured to a respective mounting bracket 128 (see also, e.g., FIGS. 3A-3B). The mounting brackets 128 are configured to be secured to a mounting structure 150. In some embodiments, the mounting structure 150 is a monopole antenna. The assembly 100 of the present invention can provide space under an antenna to work while also providing a work platform on which a technician can stand.

Referring to FIGS. 3A-3B, each platform 120 of the assembly 100 may comprise a frame 121, a mounting plate 127, a grating 122, and at least two grating edge members 123. In some embodiments, the platform 120 is formed of a weldment. In some embodiments, the platform 120 may comprise galvanized steel. In some embodiments, the frame 121 of the platform 120 comprises an elongated, hollow main support member 126 with a rectangular cross-section. In some embodiments, the frame 121 of the platform 120 further comprises a plurality of auxiliary support members 124. The plurality of auxiliary support members 124 are attached orthogonally to the main support member 126. In some embodiments, the auxiliary support members 124 have an elongate, hollow shape with a square or rectangular cross-section.

Still referring to FIGS. 3A-3B, the platform 120 may further comprise at least two grating edge members 123. The at least two grating edge members 123 are coupled to the auxiliary support members 124. As shown in FIGS. 3A-3B, the ends 124e of each support member 124 extend outwardly a distance (D) passed the grating edge members 123. This will allow the horizontal pipe members 114 of the platform assembly 100 to be supported by and/or engage with the support members 124, thereby providing additional structural support to the platform 120 and to antennas mounted on the platform 120. As discussed in further detail below, in some embodiments, the ends 124e of each support member 124 may also include a securing feature 140 (e.g., a connection bracket) to help further secure the horizontal pipe members 114 to the support members 124.

In addition, each platform 120 further comprises a grating 122 coupled to the at least two grating edge members 123. The grating 122 may be supported by the two grating edge members 123, the auxiliary support members 124, and the main support member 126, thereby providing a work platform on which a technician can stand.

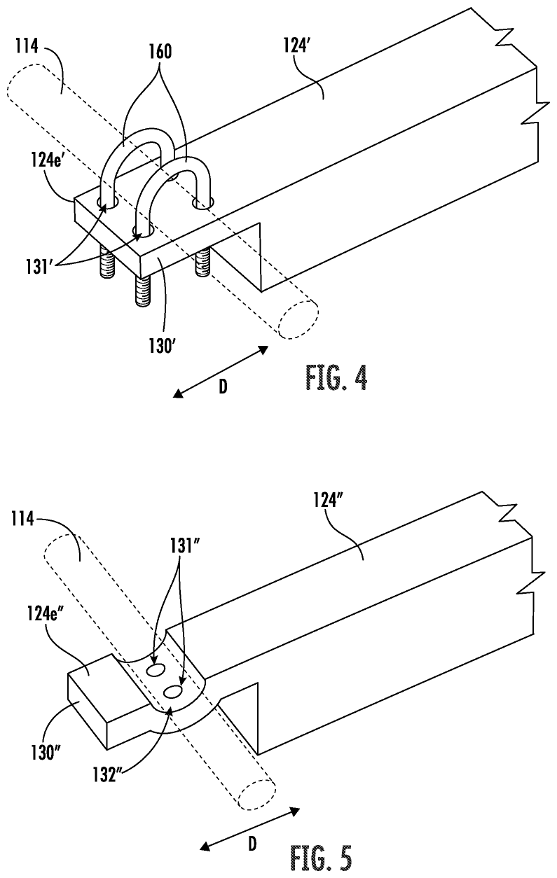

FIGS. 4-5 illustrate alternative configurations for the extended ends 124e of the support members 124 according to embodiments of the present invention. The alternative configurations may allow a horizontal pipe member 114 to be further supported and secured, and in some embodiment fixed, to a respective support member 124. For example, as shown in FIG. 4, in some embodiments, the extended end 124e ′ of the support member 124′ may comprise a flanged edge 130′ having a plurality of apertures 131′. Each of the apertures 131′ may be sized and configured to receive a respective fastener 160, such as a U-bolt. As shown in FIG. 4, a horizontal pipe member 114 may be supported by the extended flanged edge 130′ of the support member 124′ and secured to the respective support member 124′ via one or more U-bolt(s) 160 and accompanying nuts (not shown).

As shown in FIG. 5, in some embodiments, the extended flanged edge 130″ of the support member 124″ may comprise a concave recess 132″. The recess 132″ is sized and configured to generally correspond to the outer diameter of the horizontal pipe member 114. This allows the horizontal pipe 114 to be held within the recess 132″ of the support member 124″. In some embodiments, the recess 132″ includes one or more apertures 131″. Each of the apertures 131″ is sized and configured to receive a respective fastener (e.g., a threaded bolt). The horizontal pipe member 114 may be supported within the recess 132″ in the extended flanged edge 130″ of the support member 124″ and secured to the respective support member 124″ via one or more such fastener(s) (not shown).

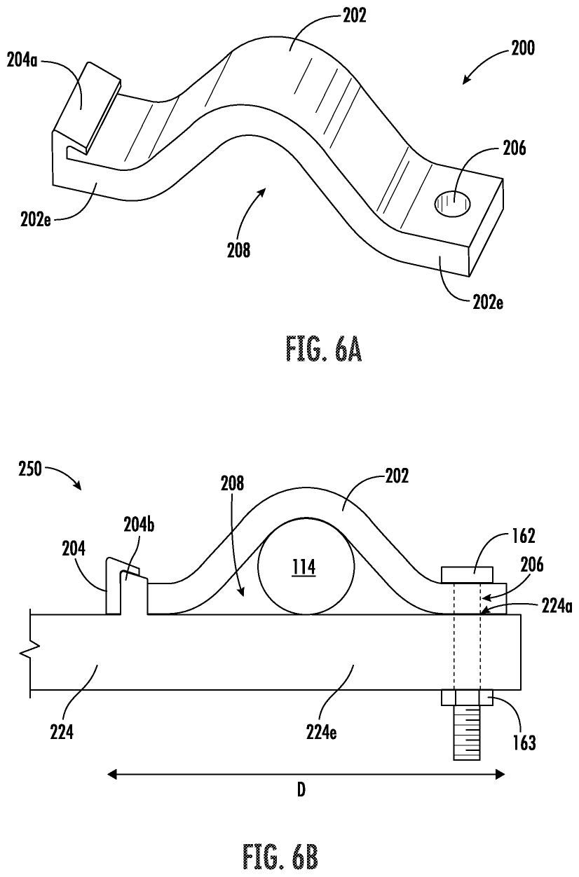

Referring to FIGS. 6A-6B, a platform connection bracket 200 and associated assembly 250 according to embodiments of the present invention are illustrated. The connection bracket 200 is configured to further secure a horizontal pipe member 114 to a respective platform support member 224.

As shown in FIG. 6A, the connection bracket 200 includes a main body 202 having opposed flanged ends 202e. The main body 202 has an arcuate shape that forms a recessed area 208 that is sized and configured to receive the outer diameter of a horizontal member 114 (see, e.g., FIG. 6B). In some embodiments, one of the flanged ends 202e of the connection bracket 200 includes an aperture 206. The aperture 206 is sized and configured to receive a fastener 162 (e.g., a threaded bolt) (see, e.g., FIG. 6B). The other flanged end 202e includes a securing feature 204a.

Similar to the platform support members described herein, each platform support members 224 of assembly 250 have extended ends 224e. Each extended end 224e includes a corresponding securing feature 204b configured to engage with the securing feature 204a of the connection bracket 200. For example, in some embodiments, the securing feature 204a of the connection bracket 200 is a hook or slanted edge and the securing feature 204b of the support member 224 is a latch or corresponding slanted edge. The extended end 224 also includes an aperture 224a that is sized and configured to receive the fastener 162.

As shown in FIG. 6B, the securing feature 204a on the connection bracket 200 engages the corresponding securing feature 204b on the support member 224 and the horizontal pipe member 114 is received within the recessed area 208 of the connection bracket 200. The aperture 206 of the connection bracket 200 aligns with the aperture 224a in the extended end 224e of the support member 224, thereby allowing the fastener 162 (e.g., a threaded bolt) to be inserted through both apertures 206, 224a. A nut 163 may be used with the fastener 162, thereby securing the connection bracket 200 to the support member 224. As shown in FIG. 6B, a horizontal pipe member 114 is supported by the extended end 224e of the support member 224 and the connection bracket 200 secures the horizontal pipe member 114 to the support member 224.

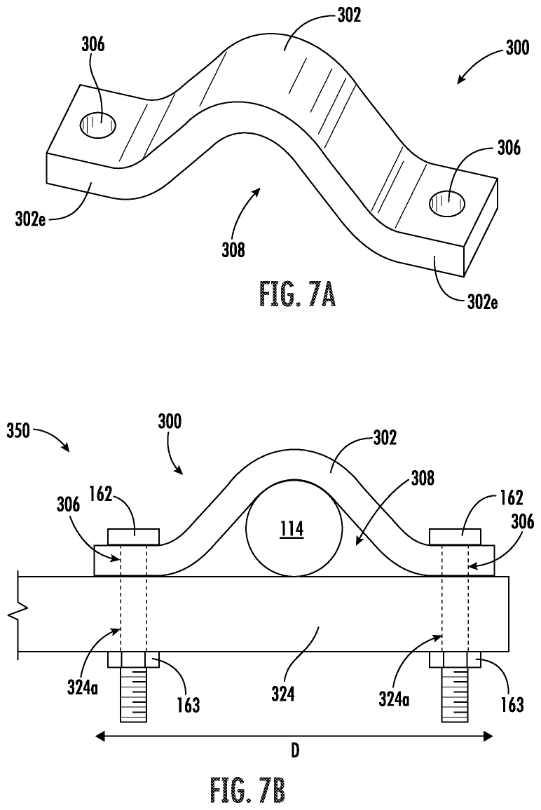

Referring to FIGS. 7A-7B, an alternative platform connection bracket 300 and associated assembly 350 according to embodiments of the present invention are illustrated. Similar to the platform connection bracket 200 describe herein, the connection bracket 300 is configured to further secure a horizontal pipe member 114 to a respective platform support member 324.

As shown in FIG. 7A, the connection bracket 300 includes a main body 302 having opposed flanged ends 302e. The main body 302 has an arcuate shape that forms a recessed area 308 that is sized and configured to receive the outer diameter of a horizontal member 114 (see, e.g., FIG. 7B). In some embodiments, each of the flanged ends 302e of the connection bracket 300 includes an aperture 306. Each aperture 306 is sized and configured to receive a respective fastener 162 (e.g., a threaded bolt) (see, e.g., FIG. 7B). Similar to the platform support members described herein, the platform support members 324 of assembly 350 have extended ends 324e. Each extended end 324e of the support members 324 includes two spaced-apart aperture 324a that are sized and configured to receive a respective fastener 162.

As shown in FIG. 7B, the apertures 306 of the connection bracket 300 align with the apertures 324a in the extended end 324e of the support member 324, thereby allowing the fasteners 162 (e.g., threaded bolts) to be inserted through the corresponding apertures 306, 324a. A nut 163 may be used with each fastener 162, thereby securing the connection bracket 300 to the support member 324. As shown in FIG. 7B, a horizontal pipe member 114 is supported by the extended end 324e of the support member 324 and received within the recessed area 308 of the connection bracket 300 such that the connection bracket 300 secures the horizontal pipe member 114 to the support member 324.

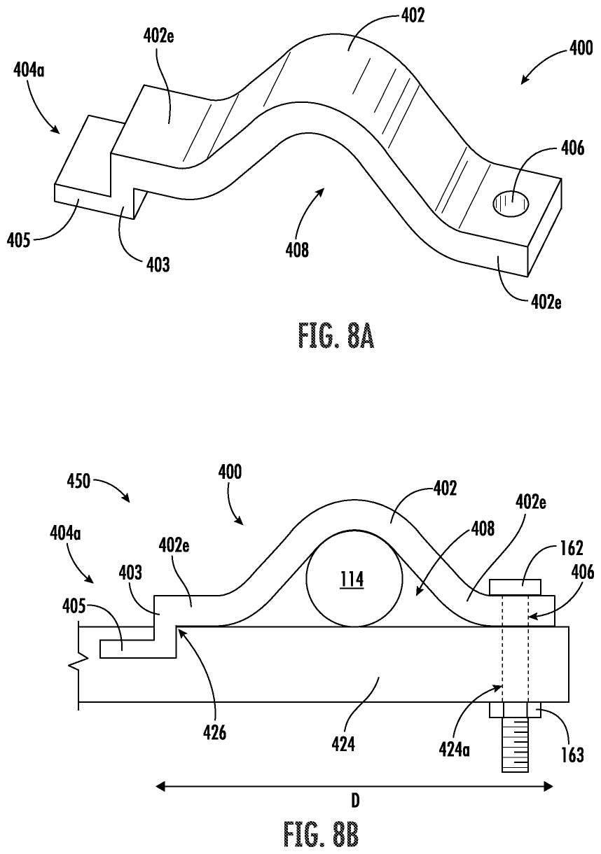

Referring to FIGS. 8A-8B, an alternative platform connection bracket 400 and associated assembly 450 according to embodiments of the present invention are illustrated. Similar to the platform connection brackets describe herein, the connection bracket 400 is configured to further secure a horizontal pipe member 114 to a respective platform support member 424.

As shown in FIG. 8A, the connection bracket 400 includes a main body 402 having opposed flanged ends 402e. The main body 402 has an arcuate shape that forms a recessed area 408 that is sized and configured to receive the outer diameter of a horizontal member 114 (see, e.g., FIG. 8B). One of the flanged ends 402e of the connection bracket 400 includes an aperture 406. The aperture 406 is sized and configured to receive a respective fastener 162 (e.g., a threaded bolt) (see, e.g., FIG. 8B). The other flanged end 402e includes a securing feature 404a.

As shown in FIG. 8A, in some embodiments, the other flanged end 402e includes a first segment 403 that extends downwardly from (i.e., perpendicularly to) the flanged end 402e and a second segment 405 that extends outwardly from (i.e., perpendicularly to) the first segment 403 to form the securing feature 404a. Similar to the platform support members described herein, the platform support members 424 of assembly 450 have extended ends 424e. Each extended end 424e of the support members 424 includes two spaced-apart apertures 424a, 426.

Aperture 424a is sized and configured to receive a respective fastener 162. As discussed further below, the other aperture 426 in the support member 424 (which may be configured as a groove or slot) may be configured to receive the second segment 405 of the securing feature 405.

As shown in FIG. 8B, the second segment 405 of the securing feature 404a of the connection bracket 400 may be received in aperture 426 on the platform support member 224 while the horizontal pipe member 114 is received within the recessed area 408 of the connection bracket 400. The other aperture 406 of the connection bracket 400 aligns with the aperture 424a in the extended end 424e of the support member 424, thereby allowing the fastener 162 (e.g., a threaded bolt) to be inserted through both apertures 406, 424a. A nut 163 may be used with the fastener 162, thereby securing the connection bracket 400 to the support member 424. As shown in FIG. 8B, the horizontal pipe member 114 is supported by the extended end 424e of the support member 424 and the connection bracket 400 secures the horizontal pipe member 114 to the support member 424.

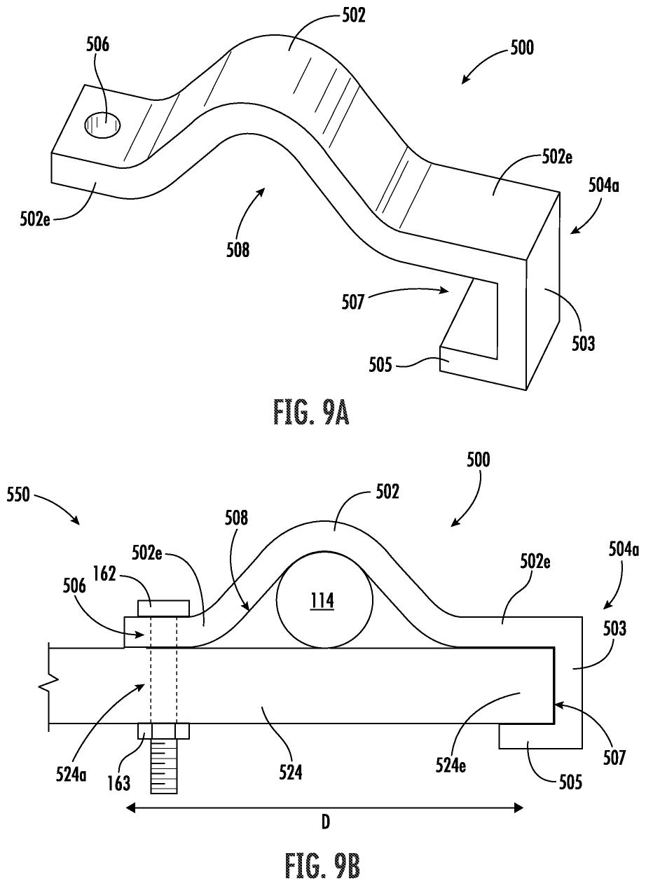

Referring to FIGS. 9A-9B, an alternative platform connection bracket 500 and associated assembly 550 according to embodiments of the present invention are illustrated. Similar to the platform connection brackets describe herein, the connection bracket 500 is configured to further secure a horizontal pipe member 114 to a respective platform support member 524.

As shown in FIG. 9A, the connection bracket 500 includes a main body 502 having opposed flanged ends 502e. The main body 502 has an arcuate shape that forms a recessed area 508 that is sized and configured to receive the outer diameter of a horizontal member 114 (see, e.g., FIG. 9B). One of the flanged ends 502e of the connection bracket 500 includes an aperture 506. The aperture 506 is sized and configured to receive a respective fastener 162 (e.g., a threaded bolt) (see, e.g., FIG. 9B). The other flanged end 502e includes a securing feature 504a.

As shown in FIG. 9A, in some embodiments, the other flanged end 502e includes a first segment 503 that extends downwardly from (i.e., perpendicularly to) the flanged end 502e and a second segment 505 that extends inwardly from (i.e., perpendicularly to) the first segment 503 to form a second recessed area 507, thereby forming the securing feature 504a. Similar to the platform support members described herein, the platform support members 524 of assembly 550 have extended ends 524e. Each extended end 524e includes an aperture 524a that is sized and configured to receive a respective fastener 162. As discussed further below, the second recessed area 507 of the securing feature 504a is sized and configured to fit on the extended end 524e of the support member 524 (see, e.g., FIG. 9B).

As shown in FIG. 9B, the extended end 524e of the support member 524 is received within the recessed area 507 of the securing feature 504a of the connection bracket 500 while the horizontal pipe member 114 is received within the recessed area 508 of the connection bracket 500. The aperture 506 of the connection bracket 500 aligns with the aperture 524a in the extended end 524e of the support member 524, thereby allowing the fastener 162 (e.g., a threaded bolt) to be inserted through both apertures 506, 524a. A nut 163 may be used with the fastener 162, thereby securing the connection bracket 500 to the support member 524. As shown in FIG. 9B, the horizontal pipe member 114 is supported by the extended end 524e of the support member 524 and the connection bracket 500 secures the horizontal pipe member 114 to the support member 524.

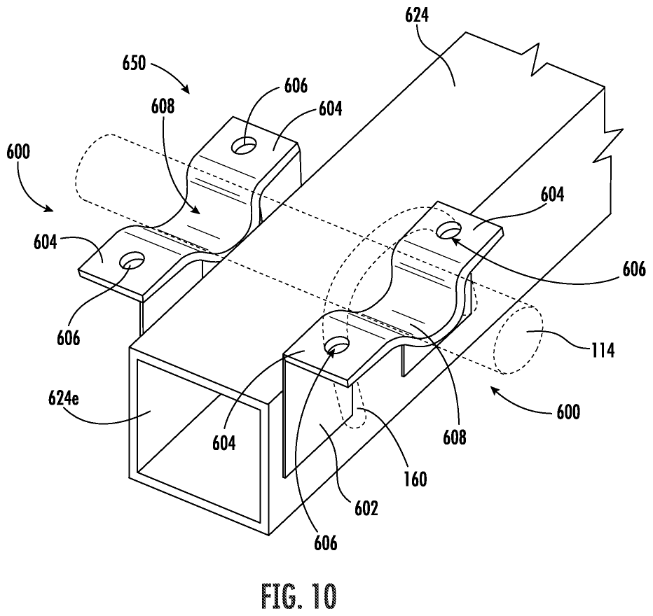

Referring to FIG. 10, alternative platform connection brackets 600 and associated assembly 650 according to embodiments of the present invention are illustrated. Similar to the platform connection brackets describe herein, the connection brackets 600 are configured to further secure a horizontal pipe member 114 to a respective platform support member 624.

As shown in FIG. 10, a pair of platform connection brackets 600 are secured to opposing sides of the extended end 624e of the support member 624 (e.g., via welding). In some embodiments, each bracket 600 has a main body 602 with a concave recessed area 608. The concave recessed area 608 of each bracket 600 is sized and configured to correspond to the outer diameter of the horizontal pipe member 114. This allows the horizontal pipe 114 to be held within the recessed areas 608 of each bracket 600. Each bracket 600 also comprises opposed flanged edges 604 extending outwardly from the recessed area 608. Each flanged edge 604 includes an apertures 606 that is sized and configured to receive a fastener 160 (e.g., a U-bolt). The horizontal pipe member 114 may be supported by the extended end 624e of the support member 624 and within the recessed areas 608 of the brackets 600 and then secured within the recessed areas 608 (and to the support member 624) via one or more fastener(s) 160, for example, U-bolts, inserted through the apertures 606.

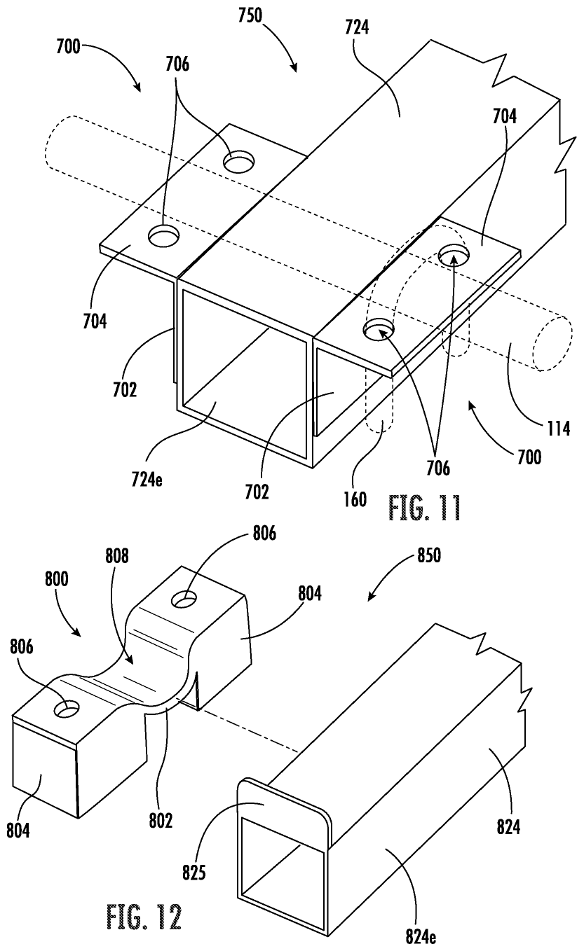

Referring to FIG. 11, alternative platform connection brackets 700 and associated assembly 750 according to embodiments of the present invention are illustrated. Similar to the platform connection brackets describe herein, the connection brackets 700 are configured to further secure a horizontal pipe member 114 to a respective platform support member 724.

The connection brackets 700 are similar to the connection brackets 600 described herein, but differ in that the connection brackets 700 do not have a concave recessed area 608 like the connection brackets 600. Instead, as shown in FIG. 11, each connection bracket 700 comprises a main body 702 and a flanged edge 704 extending (or bent) radially outwardly from the main body 702. The main body 702 of each bracket 700 is secured to opposing sides of the extended end 724e of the support member 724 (e.g., via welding). As shown in FIG. 11, each flanged edge 704 of the brackets 700 have a pair of apertures 706. The apertures 706 are sized and configured to receive a fastener (e.g., a U-bolt). The horizontal pipe member 114 may be supported by the extended end 724e of the support member 724 and the brackets 700 and then secured to the brackets 700 (and support member 724) via one or more fastener(s), for example, U-bolts, inserted through the apertures 706.

Referring to FIG. 12, an alternative platform connection bracket 800 and associated assembly 850 according to embodiments of the present invention are illustrated. Similar to the platform connection brackets describe herein, the connection bracket 800 is configured to further secure a horizontal pipe member 114 to a respective platform support member 824.

As shown in FIG. 12, the assembly 850 is similar to assembly 650 except only one connection bracket 800 is secured to a side of the support member 824 (e.g., via welding). Similar to connection brackets 600 described herein, the connection bracket 800 has a main body 802 with two side members 804 and a concave recessed area 808 therebetween. The concave recessed area 808 of each bracket 800 is sized and configured to correspond to the outer diameter of the horizontal pipe member 114. This allows the horizontal pipe 114 to be held within the recessed areas 808 of the bracket 800. The two side members 804 each include an aperture 806 that is sized and configured to receive a fastener (e.g., a U-bolt). In addition, the extended end 824e of the support member 824 includes a stop member 825. The horizontal pipe member 114 may be supported by the extended end 824e and stop member 825 of the support member 624 and within the recessed areas 808 of the brackets 800 and then secured within the recessed areas 808 via one or more fastener(s), for example, U-bolts, inserted through the apertures 806.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A monopole platform assembly, the platform assembly comprising:
a frame, the frame comprising:
an elongate, hollow main support member of rectangular cross-section; and
a plurality of elongate, hollow auxiliary support members of rectangular cross-section attached orthogonally to the main support member;
a mounting plate coupled to an end of the main support member;
at least two grating edge members coupled to the auxiliary support members; and
a grating, wherein the grating is supported by the two grating edge members, the auxiliary support members, and the main support member,
wherein opposing ends of each auxiliary support member extend a distance outwardly past the grating edge members such that the extended ends of the auxiliary support members are positioned to support a horizontal pipe member, and
wherein the extended ends of the auxiliary support members each include a feature configured to enable fixing of the horizontal pipe member thereto, wherein the feature comprises one or more platform connection brackets, each platform connection bracket being configured to further support and secure the horizontal pipe member to a respective auxiliary support member.

2. The platform assembly of claim 1, wherein the distance that the ends of each auxiliary support member extends is equal to or greater than an outer diameter of the horizontal pipe member.

3.-5. (canceled)

6. The platform assembly of claim 1, wherein each platform connection bracket comprises a main body having opposed flanged ends, the main body having an arcuate shape that forms a recessed area that is sized and configured to receive an outer diameter of the horizontal member, wherein one flanged end includes an aperture sized and configured to receive a fastener and the other flanged end includes a securing feature.

7.-8. (canceled)

9. The platform assembly of claim 1, wherein each platform connection bracket comprises a main body having opposed flanged ends, the main body having an arcuate shape that forms a recessed area that is sized and configured to receive an outer diameter of the horizontal member, wherein each flanged end includes an aperture sized and configured to receive a fastener.

10.-14. (canceled)

15. The platform assembly of claim 1, wherein the assembly includes a pair of platform connection brackets secured to opposing sides of the extended end of the auxiliary support member, each bracket having a main body with a concave recessed area and opposed flanged edges extending radially outwardly from the recessed area, each flanged edge including an aperture, wherein the concave recessed area is sized and configured to correspond to the outer diameter of the horizontal pipe member, and wherein the horizontal pipe is supported by the extended end of the auxiliary support member and concave recessed areas of the connection brackets and secured to the auxiliary support member via one or more fasteners received through the apertures of the connection brackets.

16. The platform assembly of claim 1, wherein the assembly includes a pair of platform connection brackets secured to opposing sides of the extended end of the auxiliary support member, each connection bracket comprising a main body and a flanged edge extending outwardly from the main body, each flanged edge including a pair of apertures, and wherein the horizontal pipe member is supported by the extended end of the auxiliary support member and flanged edges of the connection brackets and secured to the auxiliary support member via one or more fasteners inserted through the apertures of the connection brackets.

17. The platform assembly of claim 1, wherein the connection bracket has a main body with two side members and a concave recessed area therebetween, each of the side members including an aperture, wherein the extended end of the auxiliary support member has a stop member extending upwardly therefrom and the connection bracket is secured to a side of the extended end of the auxiliary support member, and wherein the horizontal pipe member is supported by the extended end and stop member of the auxiliary support member and within the recessed area of the connection bracket and secured via one or more fasteners inserted through the apertures on the connection bracket.

18. A monopole platform assembly, the platform assembly comprising:
a frame, the frame comprising:
an elongate, hollow main support member of rectangular cross-section; and
a plurality of elongate, hollow auxiliary support members of rectangular cross-section attached orthogonally to the main support member;
a mounting plate coupled to an end of the main support member;
at least two grating edge members coupled to the auxiliary support members;
a grating, wherein the grating is supported by the two grating edge members, the auxiliary support members, and the main support member; and
a pair of platform connection brackets, each connection bracket comprising a main body and a flanged edge extending outwardly from the main body, each flanged edge including a pair of apertures;
wherein opposing ends of each auxiliary support member extend a distance outwardly past the grating edge members such that the extended ends of the auxiliary support members are positioned to support a horizontal pipe member, and
wherein the pair of platform connection brackets are secured to opposing sides of the extended end of the auxiliary support member and the flanged edges of each platform connection bracket further supports and secures the horizontal pipe member to a respective auxiliary support member via one or more fasteners inserted through the apertures of the connection brackets.

19. The platform assembly of claim 18, wherein the main body of each platform connection bracket comprises opposed flanged ends, the main body having an arcuate shape that forms a recessed area that is sized and configured to receive an outer diameter of the horizontal member, wherein one flanged end includes an aperture sized and configured to receive a fastener and the other flanged end includes a securing feature.

20.-21. (canceled)

22. The platform assembly of claim 18, wherein the main body of each platform connection bracket comprises opposed flanged ends, the main body having an arcuate shape that forms a recessed area that is sized and configured to receive an outer diameter of the horizontal member, wherein each flanged end includes an aperture sized and configured to receive a fastener.

23.-27. (canceled)

28. The platform assembly of claim 18, wherein the main body of each platform connection bracket has a concave recessed area and opposed flanged edges extending radially outwardly from the recessed area, each flanged edge including an aperture, wherein the concave recessed area is sized and configured to correspond to the outer diameter of the horizontal pipe member, and wherein the horizontal pipe is supported by the extended end of the auxiliary support member and concave recessed areas of the connection brackets and secured to the auxiliary support member via one or more fasteners received through the apertures of the connection brackets.

29. (canceled)

30. The platform assembly of claim 18, wherein the main body of each connection bracket has two side members and a concave recessed area therebetween, each of the side members including an aperture, wherein the extended end of the auxiliary support member has a stop member extending upwardly therefrom and the connection bracket is secured to a side of the extended end of the auxiliary support member, and wherein the horizontal pipe member is supported by the extended end and stop member of the auxiliary support member and within the recessed area of the connection bracket and secured via one or more fasteners inserted through the apertures on the connection bracket.

31. A platform assembly, the platform assembly comprising:
a mounting structure; and
at least three platforms, each platform comprising:
a frame, the frame comprising:
an elongate, hollow main support member of rectangular cross-section; and
a plurality of elongate, hollow auxiliary support members of rectangular cross-section attached orthogonally to the main support member;
a mounting plate coupled to an end of the main support member;
at least two grating edge members coupled to the auxiliary support members;
a grating, wherein the grating is supported by the two grating edge members, the auxiliary support members, and the main support member; and
one or more platform connection brackets,
wherein opposing ends of each auxiliary support member extend a distance outwardly past the grating edge members such that the extended ends of the auxiliary support members are positioned to support a horizontal pipe member and the horizontal pipe member is coupled to at least two auxiliary support members of one of the platforms,
wherein each platform connection bracket is configured to further support and secure the horizontal pipe member to a respective auxiliary support member, and
wherein each platform is secured to the mounting structure by the mounting plate.

32. The platform assembly of claim 31, wherein the distance that the ends of each auxiliary support member extends is equal to or greater than an outer diameter of the horizontal pipe member.

33.-34. (canceled)

35. The platform assembly of claim 31, wherein the mounting structure is a monopole antenna.

36. The platform assembly of claim 1, wherein each of the platform connection brackets have an L-shaped profile.

37. The platform assembly of claim 18, wherein the one or more fasteners are U-bolts.

38. The platform assembly of claim 31, wherein the platform assembly comprises a pair of connection brackets, each connection bracket secured to opposing sides of the extended end of the auxiliary support member.
